(19) United States
(12) Patent Application Publication
(10) Pub. No.: US 2025/0105603 A1
(43) Pub. Date: Mar. 27, 2025

(54) CABLE PROTECTOR

(71) Applicant: Schlumberger Technology Corporation, Sugar Land, TX (US)

(72) Inventors: Song Wang, Shanghai (CN); Jun Jiang, Shanghai (CN); Pablo Cabrera Ponce, Rio de Janeiro (BR)

(21) Appl. No.: 18/832,828

(22) PCT Filed: May 12, 2023
(86) PCT No.: PCT/US2023/022062

§ 371 Date: Jul. 24, 2024

Related U.S. Application Data
(60) Provisional application No. 63/364,652, filed on May 13, 2022.

(51) Int. Cl. H02G 3/04; E21B 17/02; E21B 17/10

(52) U.S. Cl. CPC H02G 3/0481; E21B 17/026; E21B 17/10

(57) ABSTRACT

A system for use in a well comprises: a well string; a cable deployed along well tubing; and a cable protector securing the cable to the well tubing, the cable protector comprising: a first cable protector body; a second cable protector body comprising: a cut-out extending from an end surface of the second protector body, the cut-out bordered or defined by a base and two side walls; and a J or L shaped slot formed in each side wall of the cut-out; and a fastening mechanism comprising: a pivot comprising a body having a bore extending axially therethrough; and a connection bolt configured to be inserted through the bore of the pivot.

### CROSS-REFERENCE TO RELATED APPLICATION

The present document is based on and claims priority to U.S. Provisional Application Ser. No. 63/364652, filed May 13, 2022, which is incorporated herein by reference in its entirety.

### BACKGROUND

The present disclosure relates to cable protectors for downhole control lines. Hydrocarbon fluids such as oil and natural gas are obtained from a subterranean geologic formation, referred to as a reservoir, by drilling a well that penetrates the hydrocarbon-bearing formation. Once a wellbore is drilled, various forms of well completion components may be installed to control and enhance the efficiency of producing various fluids from the reservoir. For example, electric submersible pump (ESP) systems are deployed downhole to pump the fluids to a surface location or other collection location. ESP systems and other completion related components and systems may be controlled via inputs provided through a cable routed downhole along the completion. The cable may comprise a variety of conduits, electrical conductors, hydraulic control lines, and/or other types of communication lines.

The structural integrity of the cable may be preserved by employing cable protectors along the completion equipment. The cable protectors are used to protect the cable from damage during deployment downhole and to prevent relative movement between the cable and the corresponding completion string. Cable protectors are constructed to engage the specific dimensions of a given cable and to thus trap the cable and prevent axial movement of the cable relative to the completion tubing.

### SUMMARY

In some configurations, a system for use in a well includes a well tubing, a cable deployed along the well tubing, and a cable protector securing the cable to the well tubing. The cable protector includes a first cable protector body, a second cable protector body, and a fastening mechanism. The second cable protector body includes a cut-out extending from an end surface of the second cable protector body and defined or bordered by a base and two side walls, and a J or L shaped slot formed in each side wall of the cut-out. The fastening mechanism includes a pivot and a connection bolt. The pivot includes a body having a bore extending axially therethrough. The connection bolt is configured to be inserted through the bore of the pivot.

The pivot can include a pivot arm extending radially outwardly from the body. The pivot arm can be partially cylindrical with a flat edge. During installation, the pivot can be configured to be inserted into the cut-out and the pivot arm configured to be inserted into the slots formed in the side walls.

In some configurations, a cable protector includes a first cable protector body, a second cable protector body, and a fastening mechanism. The second cable protector body includes a cut-out extending from an end surface of the second cable protector body and defined or bordered by a base and two side walls, and a J or L shaped slot formed in each side wall. The fastening mechanism includes a pivot and a connection bolt. The pivot includes a body having a bore extending axially therethrough and a pivot arm extending radially outward from the body. The pivot arm is generally cylindrical with a flat edge. The connection bolt is configured to be inserted through the bore of the pivot.

An axial dimension of the pivot arm is less than a width of the slot. A width of the slot is less than a diameter of a cylindrical portion of the pivot arm. A diameter of a cylindrical portion of the pivot arm is less than a diameter of an enlarged top end of the slot. A distance from a top surface of the pivot to a top of the pivot arm is less than a distance from a bottom of the slot to the base of the cut-out. A distance from a bottom of the slot to the base of the cut-out is less than a distance from a bottom of the pivot arm to a bottom surface of the pivot. A distance from a bottom of the slot to the base of the cut-out is less than a sum of a distance from a top surface of the pivot to a top of the pivot arm and a height of a head of the connection bolt.

A cable protector can include a first cable protector body and a second cable protector body having a cut-out and a J or L shaped slot. A fastening mechanism for the cable protector can include a pivot having a pivot arm with a flat edge. In some configurations, a method of installing the fastening mechanism includes orienting the pivot such that the flat edge of the pivot arm faces an end surface of the second cable protector body; inserting the pivot into the cut-out of the second cable protector body and the pivot arm into the slot; rotating the pivot 90° in a first direction; sliding the pivot in the cut-out such that the pivot arm slides in the slot toward the end surface; rotating the pivot 90° in the first direction; and inserting a connection bolt through the pivot.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 shows an example well system deployed in a wellbore, including a plurality of cable protectors.

FIG. 2 shows an example existing cable protector.

FIG. 3 shows an example existing cable protector fastening mechanism.

FIG. 4 shows another example existing cable protector fastening mechanism.

FIG. 5 shows example possible casting defects and design imperfects of the fastening mechanism of FIG. 4.

FIG. 6 shows an example cable protector fastening mechanism according to the present disclosure.

FIG. 7 shows an installation procedure of the fastening mechanism of FIG. 6.

FIG. 8 shows dimensions of the fastening mechanism of FIG. 6.

FIG. 9 shows an anti-falling-out mechanism of the fastening mechanism of FIG. 6.

FIG. 10 shows a connection bolt and anti-falling-out mechanism of the fastening mechanism of FIG. 6.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

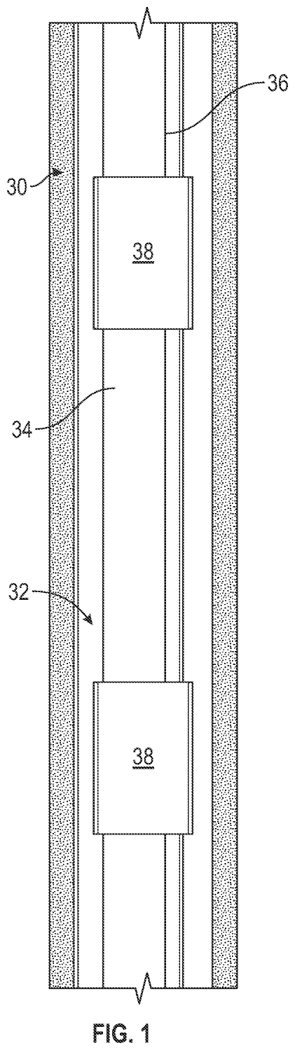

Referring generally to FIG. 1, an embodiment of a well system 30 is illustrated as deployed in a wellbore 32. The well system 30 comprises well tubing 34, e.g. completion tubing, and a cable or cables 36 deployed along the well tubing 34. Additionally, the well system 30 comprises at least one and often a plurality of cable protectors 38 secured to the well tubing 34.

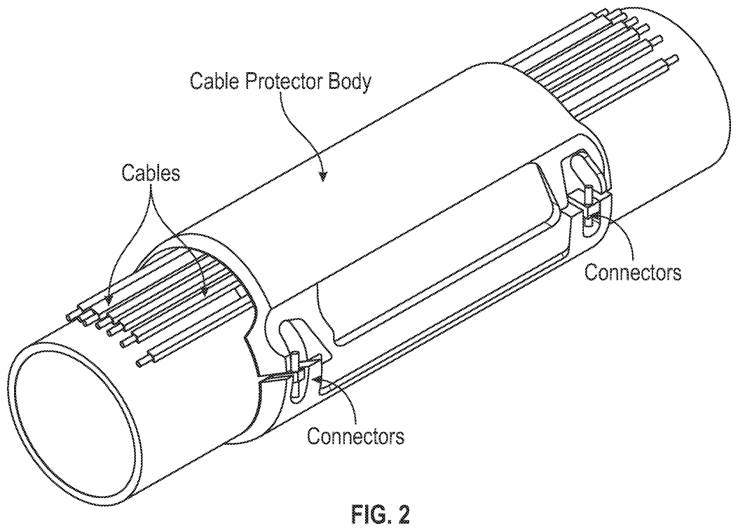

Downhole equipment in oil and gas wells is controlled and powered through electric and hydraulic control lines. Cable Protectors are used to hold the weight and protect these control lines and cables from being damaged during the Running In Hole (RIH) and Pulling Out Of Hole (POOH) and during the life of the completion in the well. Various types of cable protectors exist in the market for different applications and different environments. For example, in offshore subsea wells, the completion string is subjected to excessive cyclical action caused by waves heave and possible rig misalignment while RIH, causing significant risk of damage to cable and control lines damage. The Lasalle Harsh Environment type protector, shown in FIG. 2, was designed to withstand such subsea environment forces experienced by a protector during RIH or POOH or in cases when operations have been suspended (due to bad weather for example) and the completion string is subjected to excessive cyclical forces due to wave heave and possible rig misalignment.

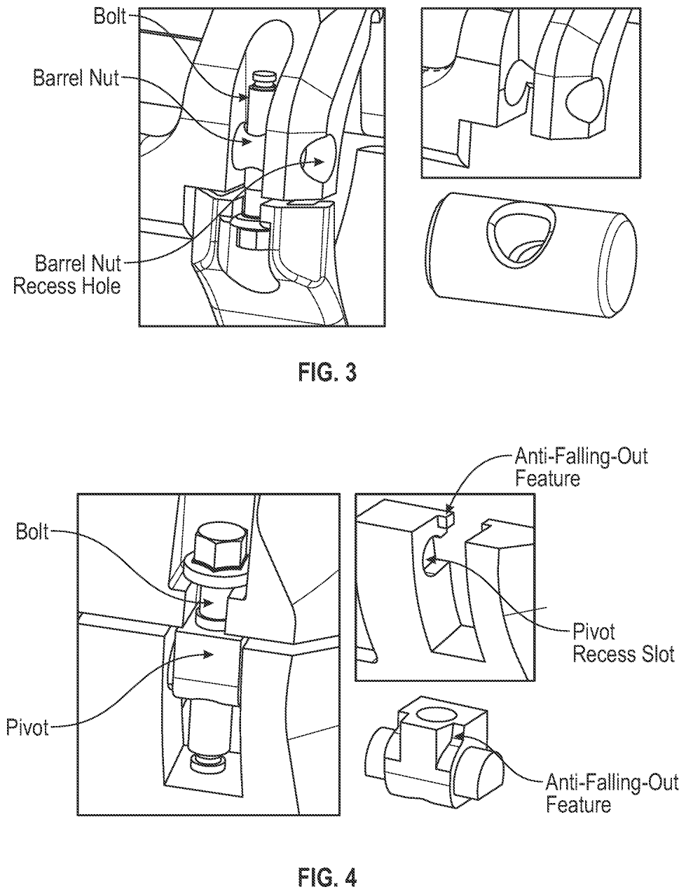

Standard cross coupling cable protectors include a traditional bolt and barrel nut fastener, for example as shown in FIG. 3. The barrel nut OD must be large enough to machine female threads, so the overall fastener requires more space on casting, leading to a large running OD for the cable protector. The bolt and barrel nut fastener therefore does not work for tight applications.

The harsh environment protector shown in FIG. 2 instead includes a pivot fastener and anti-falling-out features, as shown in FIG. 4. The fastener includes a bolt and pivot. The pivot fastener can be installed quickly during operation, and has a more compact geometry compared to barrel nuts, which allows the cable protector to be used in a wider range of applications, especially when casting drift is tight.

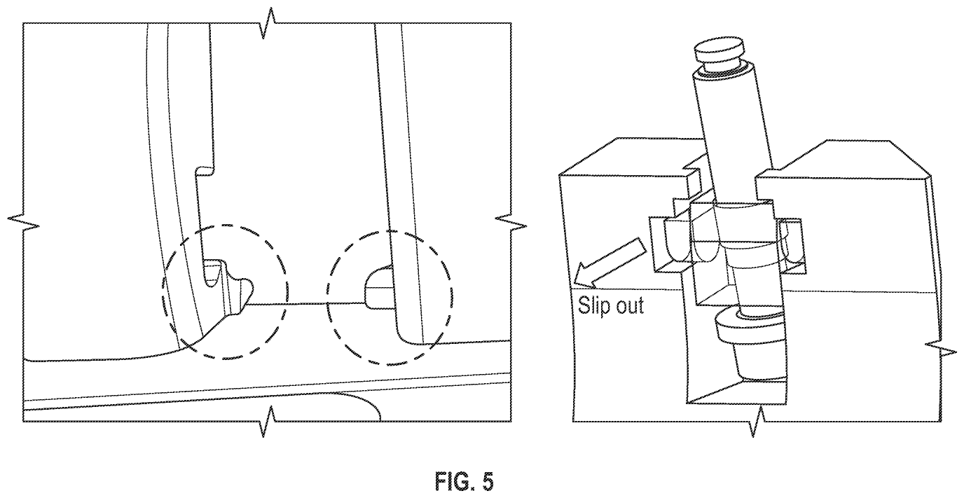

Lasalle harsh environment cable protectors such as shown in FIG. 2 are manufactured using a lost-wax casting process, during which casting defects, such as misrun, can occur while forming sharp edges or corners or features with limited sizes. The pivot recess slot includes a special profile and anti-falling-out block, which are critical features to prevent the pivot from falling out of the cable protector after the bolt and pivot are installed. However, the anti-falling-out features have compact geometries and are susceptible to misrun defects, which could result in the pivot falling out of the cable protector and/or imperfections on the anti-falling-out block. Additionally, as shown in FIG. 5, the pivot can fall out if the bolt is installed as shown.

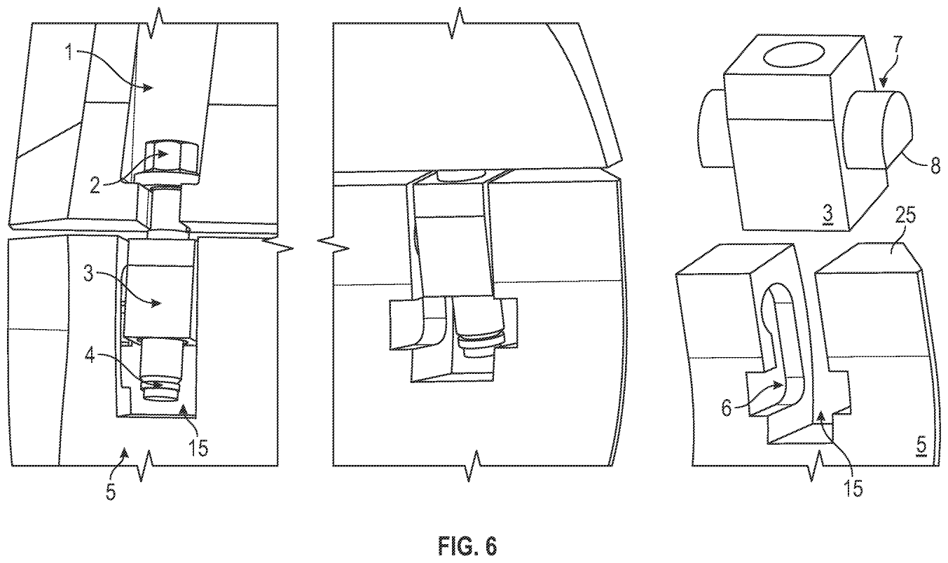

The present disclosure provides a J-type fastening mechanism and method for use with a cable protector, such as a harsh environment cable protector. The J-type fastening mechanism advantageously reduces or eliminates the pivot falling-out risk and/or reduces the rate of casting defects in the foundry. As shown in FIG. 6, the J-type fastening mechanism is configured to secure a first cable protector body 1 to a second cable protector body 5. The J-type fastening mechanism includes a connection bolt 2, a simplified pivot 3, and a lock washer 4. The connection bolt 2 connects the first cable protector body 1 and the second cable protector body 5.

The second cable protector body 5 includes a cut out or recess 15 extending into the second body 5 from an end surface 25 of the second body 5. The second body 5 includes a J or L shaped pivot recess slot 6. As shown, the pivot recess slot 6 can be formed as a pair of slots 6 formed in side walls of the cut out 15. The simplified pivot 3 includes a through bore extending axially through a body of the pivot 3. The through bore can include female threads. The simplified pivot 3 includes a pivot rotating arm 7 projecting outwardly (e.g., radially or perpendicularly to the through bore) from the body of the pivot 3. The pivot rotating arm 7 has an outer diameter that is at least partially cylindrical or circular with a flat edge 8. The pivot arm 7 therefore has a greater dimension in the Z-axis than axially. The pivot rotating arm 7 is installed into the pivot recess slot 6. The lock washer 4 prevents the connection bolt 2 from rotating out of the simplified pivot 3. Compared to the pivot fastener of FIG. 4, the J-type fastener advantageously has a simplified geometry which allows for improved and/or easier casting. The J-type fastener advantageously reduces or eliminates the risk of the simplified pivot 3 or connection bolt 2 falling out.

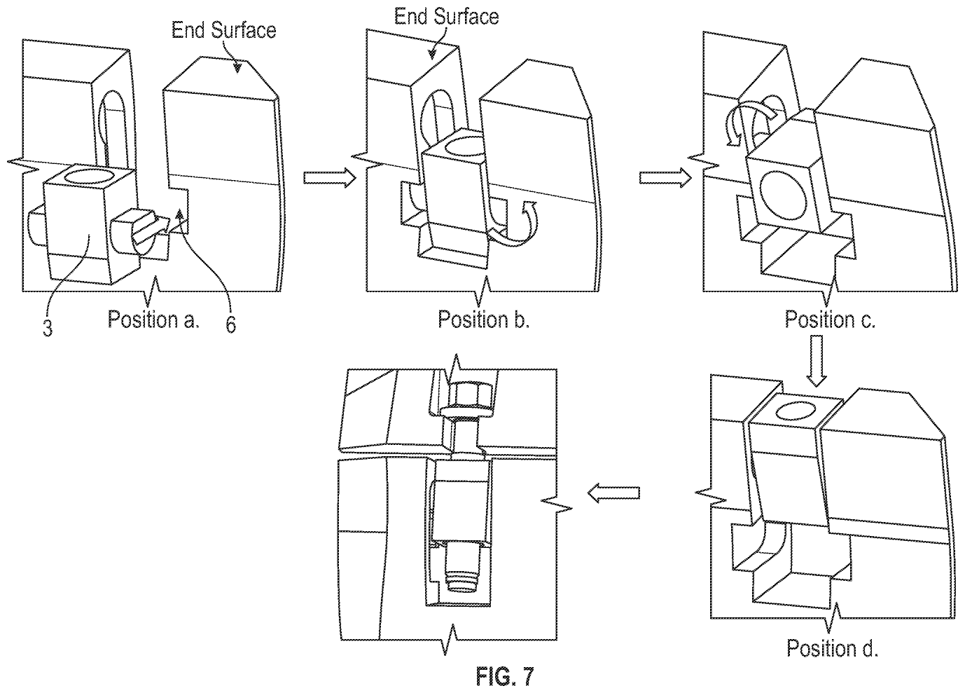

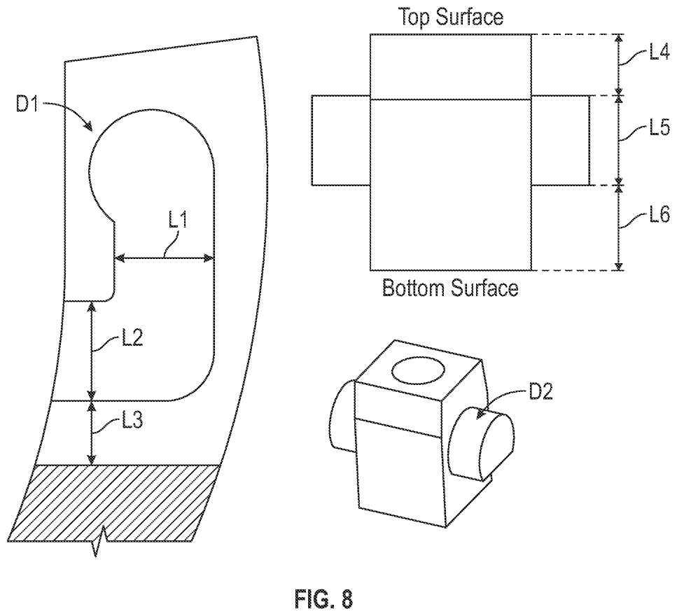

FIG. 7 illustrates an installation procedure for a fastening mechanism according to the present disclosure, for example as shown in FIG. 6. First, the pivot 3 is oriented relative to the pivot recess slot 6 as shown in position A with the flat edge 8 of the pivot rotating arm 7 facing the end surface 25 of the second body 5 (in other words, facing or pointing towards the first body 1). The pivot 3 is inserted into the cut-out 15 with the pivot arm 7 inserted into the base of the slot 6 (with the base of the slot 6 being positioned toward or proximate a base of the cut out 15 and a top of the slot 6 being positioned toward or proximate the end surface 25) as shown in position B.

The pivot 3 is then rotated 90° degrees and moved upward toward the top of the slot 6 as shown in position C. The axially-extending portions of the slots 6 are sized such that when the pivot 3 is oriented axially, as shown in position A, the Z-axis dimension of the pivot arm 7 is greater than that of the slot 6 such that the arm 7 cannot move axially in the slot 6. With the pivot 3 turned 90°, the reduced dimension of the pivot arm 7 due to the flat edge 8 is less than the slot 6 such that the pivot arm 7 can move axially along the slot 6. As shown, the slots 6 can have an enlarged and/or generally circular top portion. The pivot 3 is moved upward in the slot 6 until the pivot arm 7 is in the enlarged top portion of the slot 6. The pivot 3 is then rotated another 90° as shown in position D. The top or upward facing surface of the pivot 3 in the orientation of position A therefore ends up as the bottom or downward facing surface in the final orientation of position D. The flat edge 8 therefore ends up downward facing or facing the base of the slot 6.

Position D shows the working orientation of the pivot 3. The connection bolt 2 is then installed in a recess of the first body 1 and through the through bore of the pivot, and the lock washer 4 is installed. The pivot 3 is therefore secured in the slot 6.

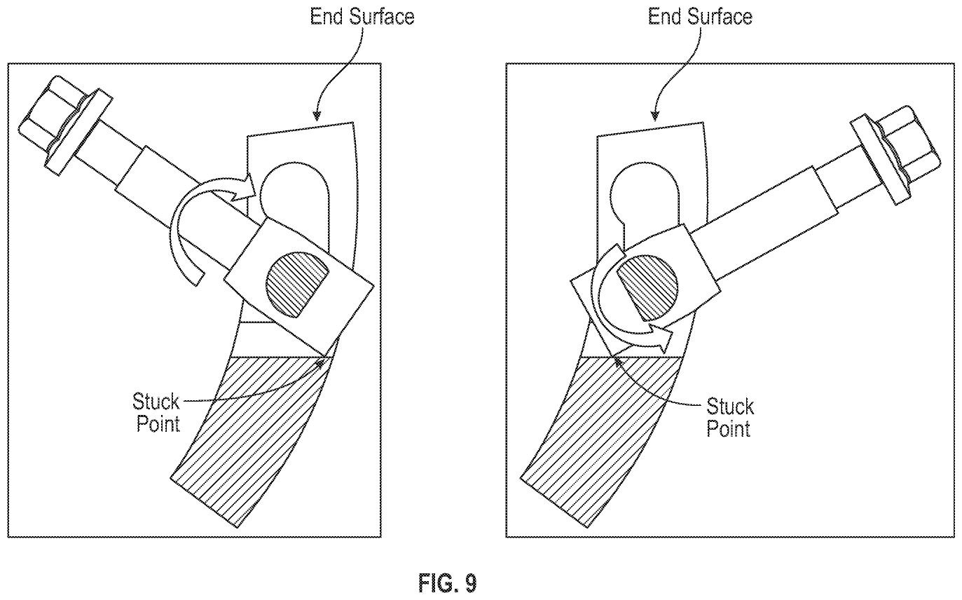

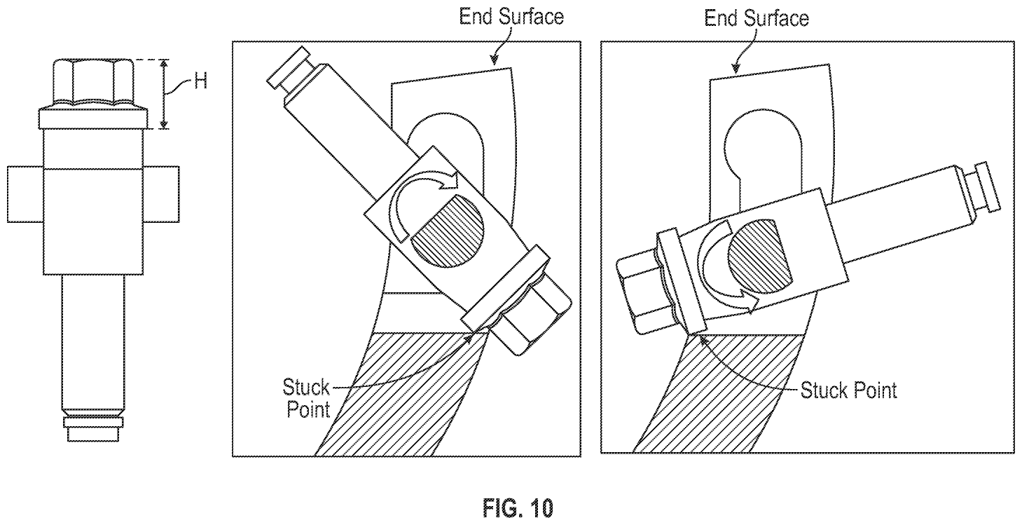

FIGS. 8 and 10 illustrate critical dimensions of the fastening mechanism. L1, L2, L3, and D1 refer to dimensions of the slot 6. L4, L5, L6, and D2 refer to dimensions of the pivot 3. H refers to a dimension of the bolt 2. To ensure successful installation, the following rules should be met:

$$L 5 < ( L 1 \& L 2 ) < D 2 < D 1 AND \qquad [ 1 ]$$

$$L 4 < L 3 \qquad [ 2 ]$$

To ensure the pivot 3 does not fall out of the slot 6 as it is rotated, the following rules should also be met:

$$L 3 < L 6 \qquad [ 3 ]$$

$$L 3 < ( L 4 + H ) \qquad [ 4 ]$$

FIG. 9 illustrates the pivot 3, with the flat edge 8 facing at least partially downward or away from the end surface 25 and the head of the bolt 2 positioned above or upward relative to the pivot 3, rotated in either direction. If L3 is less than L6, the pivot 3 contacts the base of the cut-out 15 as it rotates, preventing the arm 7 from slipping into the L2 section of the slot 6. FIG. 10 illustrates the pivot 3, with the flat edge 8 facing at least partially upward or toward the end surface 25 and the head of the bolt 2 positioned below or downward relative to the pivot 3, rotating in either direction. If L3 is less than L4+H, the bolt head contacts the base of the cut-out 15 as it rotates, preventing the arm 7 from slipping into the L2 section of the slot 6.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. A system for use in a well comprising:
a well tubing;
a cable deployed along the well tubing; and
a cable protector securing the cable to the well tubing, the cable protector comprising:
a first cable protector body;
a second cable protector body comprising:
a cut-out extending from an end surface of the second cable protector body, the cut-out bordered or defined by a base and two side walls; and
a J or L shaped slot formed in each side wall of the cut-out; and
a fastening mechanism comprising:
a pivot comprising a body having bore extending axially therethrough; and
a connection bolt configured to be inserted through the bore of the pivot.

2. The system of claim 1, the pivot comprising a pivot arm extending radially outwardly from the body.

3. The system of claim 2, the pivot arm being partially cylindrical with a flat edge.

4. The system of claim 2, wherein during installation, the pivot is configured to be inserted into the cut-out and the pivot arm is configured to be inserted into the slots formed in the side walls.

5. A cable protector comprising:
a first cable protector body;
a second cable protector body comprising:
a cut-out extending from an end surface of the second cable protector body, the cut-out bordered or defined by a base and two side walls; and
a J or L shaped slot formed in each side wall of the cut-out; and
a fastening mechanism comprising:
a pivot comprising:
a body having a bore extending axially therethrough;
a pivot arm extending radially outward from the body, the pivot arm being generally cylindrical with a flat edge; and
a connection bolt configured to be inserted through the bore of the pivot.

6. The cable protector of claim 5, wherein an axial dimension of the pivot arm is less than a width of the slot.

7. The cable protector of claim 5, wherein a width of the slot is less than a diameter of a cylindrical portion of the pivot arm.

8. The cable protector of claim 5, wherein a diameter of a cylindrical portion of the pivot arm is less than a diameter of an enlarged top end of the slot.

9. The cable protector of claim 5, wherein a distance from a top surface of the pivot to a top of the pivot arm is less than a distance from a bottom of the slot to the base of the cut-out.

10. The cable protector of claim 5, wherein a distance from a bottom of the slot to the base of the cut-out is less than a distance from a bottom of the pivot arm to a bottom surface of the pivot.

11. The cable protector of claim 5, wherein a distance from a bottom of the slot to the base of the cut-out is less than a sum of a distance from a top surface of the pivot to a top of the pivot arm and a height of a head of the connection bolt.

12. A method of installing a fastening mechanism for a cable protector, the cable protector comprising a first cable protector body and a second cable protector body having a cut-out and a J or L shaped slot, and the fastening mechanism comprising a pivot having a pivot arm with a flat edge, the method comprising:
orienting the pivot such that the flat edge of the pivot arm faces an end surface of the second cable protector body;
inserting the pivot into the cut-out of the second cable protector body and the pivot arm into the slot;
rotating the pivot 90° in a first direction;
sliding the pivot in the cut-out such that the pivot arm slides in the slot toward the end surface;
rotating the pivot 90° in the first direction; and
inserting a connection bolt through the pivot.
